(19) United States
(12) Patent Application Publication
(10) Pub. No.: US 2003/0178759 A1
(43) Pub. Date: Sep. 25, 2003

(54) Adjustable positioning device for cabinets and construction panels

(76) Inventor: Jack Churchill Bartley JR., Henderson, NC (US)

Correspondence Address: JACK C BARTLEY, 167 TRISTEN LANE, HENDERSON, NC, 27537, US

(21) Appl. No.: 10/385,025

(22) Filed: Mar. 10, 2003

Related U.S. Application Data
(60) Provisional application No. 60/365,683, filed on Mar. 19, 2002.

(51) Int. Cl. B25B 1/20

(52) U.S. Cl. 269/37

(57) ABSTRACT

An adjustable positioning apparatus for either cabinet, workpieces or construction panels. Methods of use are disclosed. The apparatus can be used to hold and make adjustments to workpiece in precisely the facilitating position to be permanently affixed to the wall studs or ceiling joists. The adjustability of the apparatus enables one to support and position work pieces in their permanent positions at different elevations and can be quickly removed and readjusted for other elevations and different construction procedures.

### BACKGROUND OF THE INVENTION

The art of hanging cabinet workpieces and construction panels on walls and ceilings has been a hazardous, cumbersome activity. In order to secure cabinets,workpieces and panels, typically more than one worker is needed. One or two workers hold the cabinet, workpieces or panels up to the wall or ceiling while another worker secures the cabinet, workpices or panel in it's final installed location. This method is time consuming and costly. If only one worker is needed to perform the same operation time and labor costs could be reduced and produce the same results.

It is known that using different sizes and heights of sticks to prop up wall cabinets is not a safe or stable way of installation. Past inventions involving hydraulic and screw jacks have proven to be very bulky, complex to use and transport and have too many parts.

Therefore, it is desirable to provide a simple, low cost, lightweight, easily adjustable and safe method of installing or removing wall cabinet, workpieces and construction panels with great agility and ease.

The construction industry for many years has been in pursuit of a way to hold and support workpieces to make final adjustment of articles such as cabinets, ceiling frames, panels and beams for securement to wall and ceiling.

In prior art U.S. Pat. No. 4,482,130, issued Nov. 13, 1984, entitled “Vertical Lifting and Placing Apparatus” it shows that one must place a workpiece on a single platform and raise workpiece by pushing down on a tube having a handle. This shows that there is no means of adjustability within the device without placing a shim between platform and workpiece. U.S. Pat. No. 4,715,760 has the same problem of final adjustment in a horizontal position. U.S. Pat. No. 6,322,062 shows a base, a top platform and a hydraulic jack, but shows no means of variations for other related workpieces other than a single wall cabinet. U.S. Pat. No. 4,981,288 issued Jan. 1, 1991 shows device used by first having a base cabinet secured and the device clamped and sitting on a counter top thus limiting it's versatility for other construction related tasks. U.S. Pat. Nos. 1,725,329; 5,329,744; 2,242,380; 5,979,854; 4,715,760; 4,955,592 and 4,482,130 show one main vertical support member.

None of the prior art show a lifting and positioning device that has four main vertical support members in it's system, and two separate workpiece holders, excluding U.S. Pat. No. 4,955,592 issued Sep. 11, 1990 by Richard Brennan, Sr. Therefore none of the known prior art devices show that it is a multi-purpose workpiece holder capable of being used in multiple construction practices. In addition, many of the prior art lacked simplicity and a light weight capability.

### BRIEF SUMMARY OF THE INVENTION

The invention is an adjustable positioning device used to install cabinets, workpieces and construction panels. The main objective of this invention is to provide a new, inexpensive, lightweight and easily portable, simple way of installing cabinet workpieces and construction panels.

This invention has 4 (four) primary parts: a base and top platform (a top platform for holding cabinet workpieces and panels and a bottom platform for ground surface stability); a square tub member longitudinal; and a second square tub member longitudinal with adjustable capabilities.

Typical devices being used to install cabinet workpieces and panels are very complicated in design, unlike this invention which is simple to use and understand. This device can easily be adjusted for different elevations by removing pins and simply raising or lowering the top platform which is fastened to an adjustable longitudinal member to desired elevation and replacing pins. This procedure has normally required a hydraulic jack but is not necessary with this invention.

### BRIEF DESCRIPTION OF DRAWINGS

FIG. 1 is a perspective left side elevation view of an adjustable positioning device.

FIG. 2 is a right side elevation view of an adjustable positioning device.

FIG. 3 is a front elevation view of an adjustable positioning device.

FIG. 4 is a rear elevation view of an adjustable positioning device.

FIG. 5 is a plain view of a stabilizing bar for an adjustable positioning device, which is optional.

FIG. 6 is a cross section view of a top and bottom platform support of an adjustable positioning device.

FIG. 7 is a side view of a retaining clip of an adjustable positioning device.

FIG. 8 is an exploded view of a securement means of all securable parts of an adjustable positioning device.

FIG. 9 is a cross section view of an upper and lower member adjustable securement of an adjustable positioning device.

FIG. 10 is a perspective view of a lower member of an adjustable positioning device.

FIG. 11 is a perspective view of an upper member of an adjustable positioning device.

FIG. 12 is a side plain view of a top platform support as shown in FIG. 6 of an adjustable positioning device.

FIG. 13 is a plain view of a pair of adjustable positioning devices with a stabilizing bar attached.

FIG. 14 is a top plain view of a top and bottom platform of an adjustable positioning device.

FIG. 15 is a top view of a top and bottom platform attached to the upper and lower supports of an adjustable positioning device.

FIG. 16 is a perspective view of a single upper and lower support of an adjustable positioning device.

FIG. 17 is a perspective view of how an adjustable positioning device might look in actual installation of a cabinet or construction panel in the work place.

FIG. 18 is a cross section view of a top and bottom workpiece holder with means of securement to vertical members.

### DETAILED DESCRIPTION OF THE INVENTION

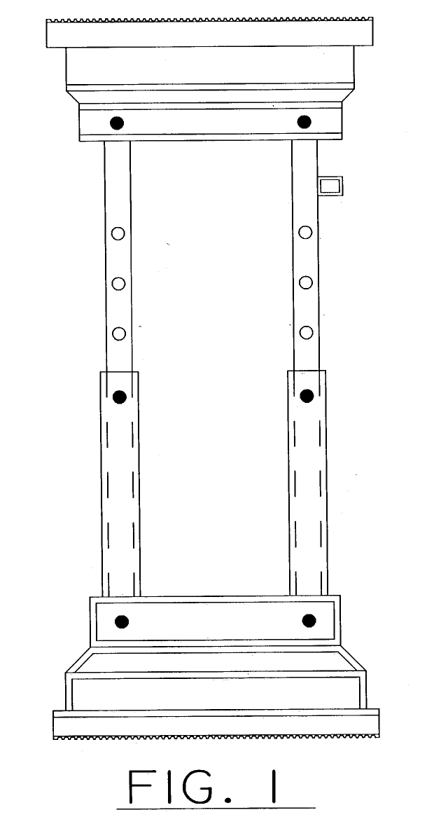

The present invention shown in FIG. 1 will be described fully with the following detailed description. The invention is illustrated by ways of example, not by means of limitations. Persons skilled in the art may modify the invention in this embodiment and the accompanying drawings and shall be interpreted as illustrative and not as limitations of the present invention.

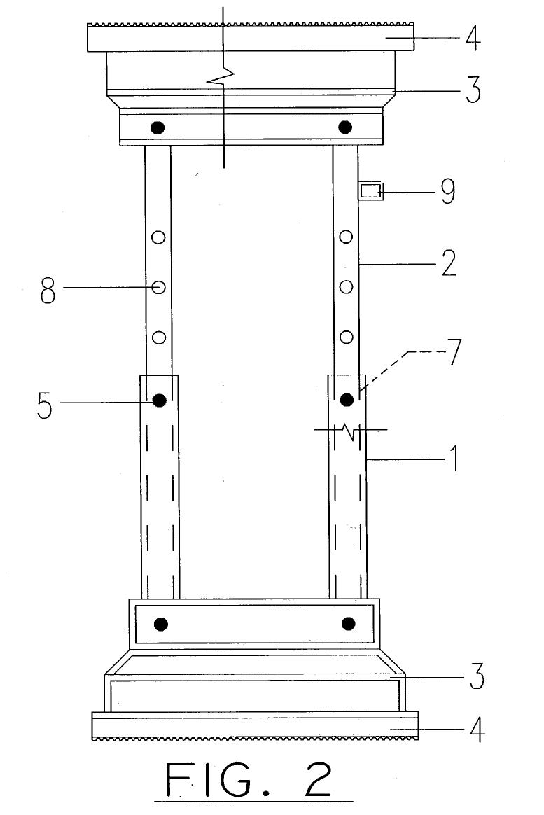

The adjustable positioning device according to this preferred embodiment of the present invention is designated in FIG. 1. Referring now to FIG. 2 of the drawing, the device is to include two vertical strut like members shown as parts 1 & 2 having adjustable means and a top and bottom work holder piece 3 which is mounted to vertical members 1 & 2. Part 3 shown as a base has securement plate 4 secured as by screws 6, best seen in FIGS. 14 & 15.

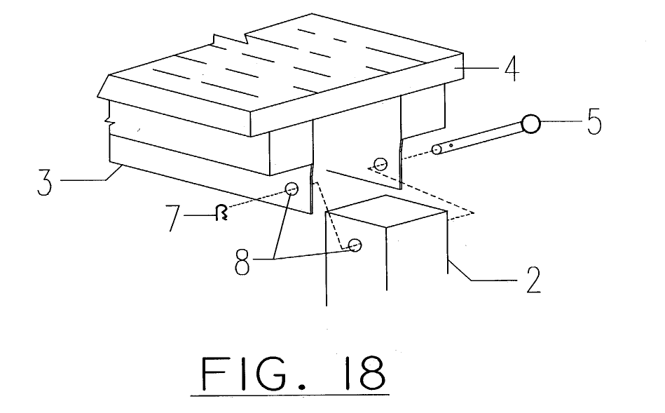

Referring to FIG. 18 shows means of securing 3 to 1&2 of a top or bottom workpiece holder by lining up all said holes and holes being a 1/4″ bored hole or more preferably 5/8″ from one side to opposite side.

Installing 5 through holes 8 by inserting 7 to retain 5. In the preferred embodiment the top and bottom sections can best be seen in FIG. 13 as labeled 3&4 are by construction are identical in shape and size.

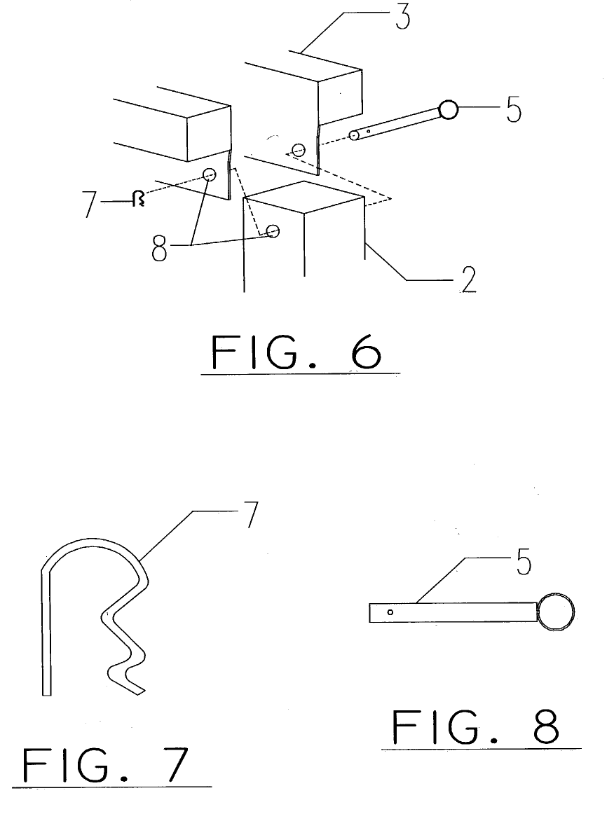

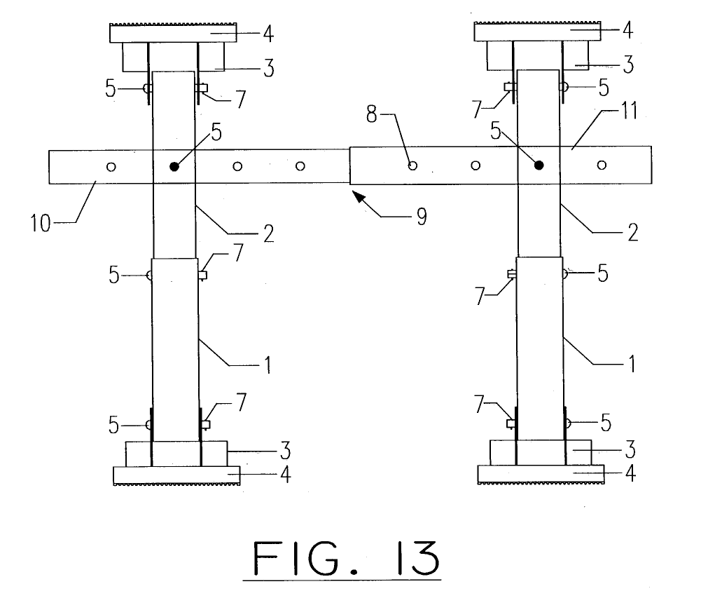

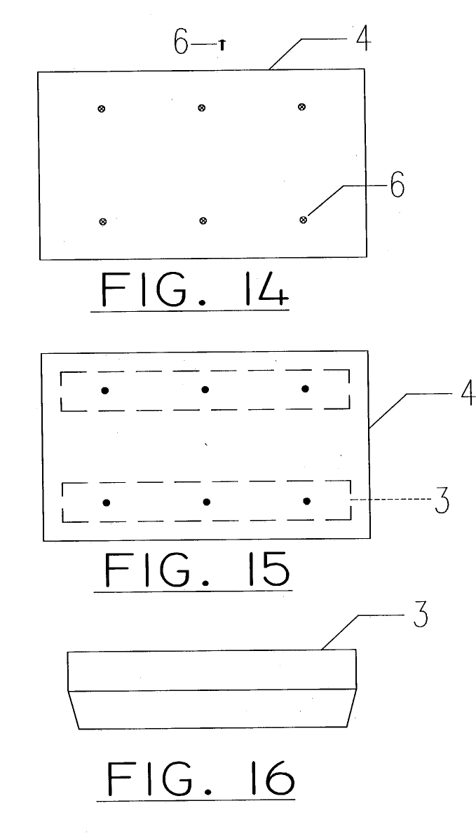

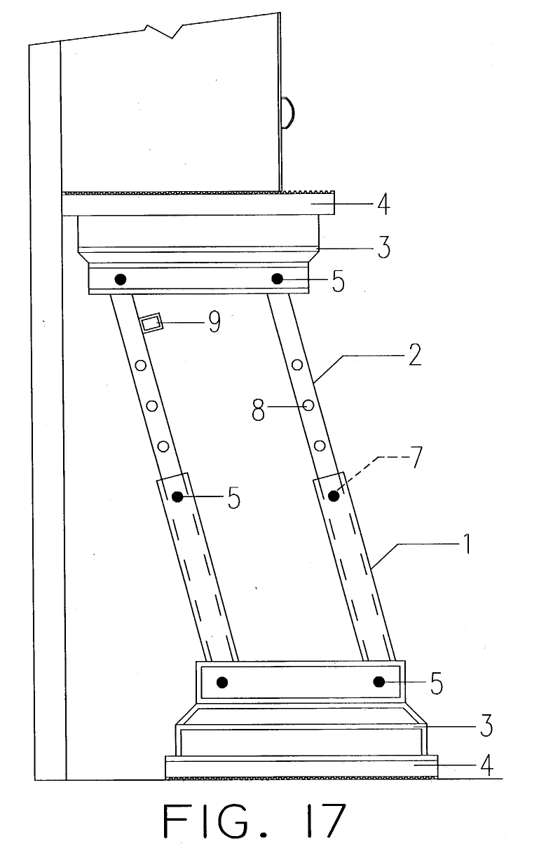

For example in the preferred embodiment, the top and bottom workpiece holders 3 are best seen in FIGS. 2-13-18, is preferably 13″ to 24″ in length when 4 is secured to 3 best shown in FIGS. 15-18 and preferably from 4″ in height to 6″ in height as 3 is a square box tubing with one side protruding preferably 2″ past the bottom of box tubing and 1/8″ thick to about 1/4″, more preferably 3/16″ thick best seen in FIG. 12.

The workpiece holder 3 is securely attached to vertical members 1-2 by means set forth, thus giving this preferred embodiment it's means of stability. Members 1-2 can best be seen in FIG. 2 (1-2) being a square tube having an overall length of 6′ to 7′, more preferably 4′8″,2 having an outside dimension of 3/4″ or about 1″ more preferably 1¼″ and should be of a light weight aluminum alloy or strong walled plastic or PVC.

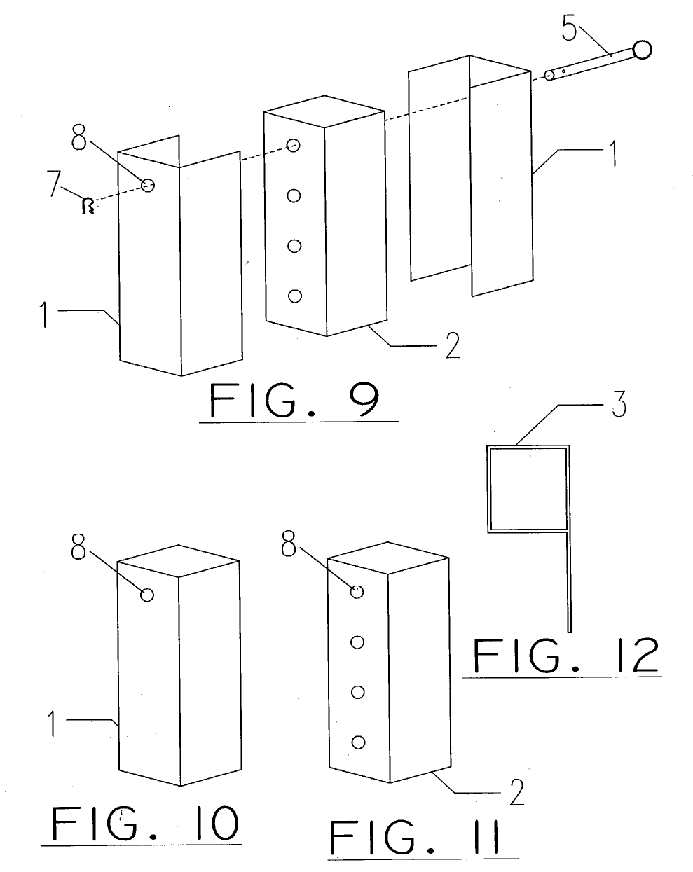

Vertical member 1, holes 8 are bored from one side of tube or to opposite side of member. 8 being a 1/4″ bore, more preferably 5/8″, as best seen in FIGS. 9 & 10 . Holes are bored approximately 1¼″ from the top of member 1. This hole is to secure 3 as best seen in FIG. 18.

Referring now to FIGS. 2-11 of the drawings square tube 2 preferably of aluminum alloy, a strong walled plastic or PVC having an inside diameter of 3/4″ or about 1″ preferably 1¼″. The vertical member 2 will receive 1 coaxially with each of the stabilizing vertical members 1 best seen in FIGS. 1-2. Each of the stabilizing members 1-2 have an upper and lower workpiece holder secured at opposite ends. The upper workpiece holder 3 is to support a workpiece best seen in FIG. 17. The lower workpiece holder 3 is to give the preferred embodiment it's means of stabilizing vertically to a ground surface, best seen in FIG. 17.

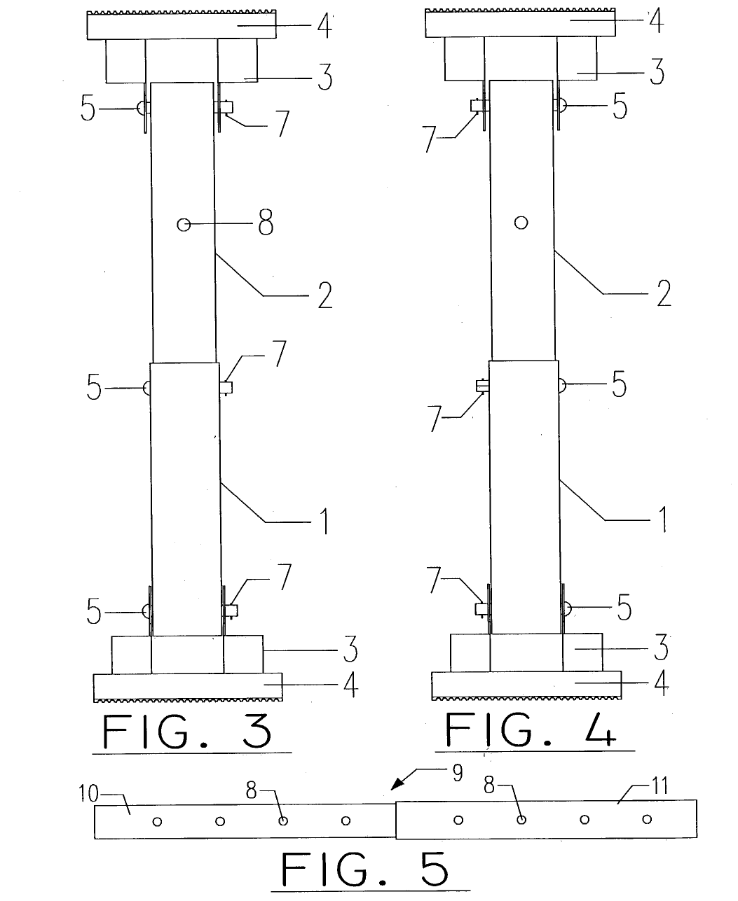

In further accordance with the invention both upper and lower plates 4 have a non skid surface made of appropriate compound best seen in FIGS. 2 & 17. As best seen in FIGS. 2 & 11 vertical member 2 having multiple holes bored along it's vertical axis from one side to opposite side, spaced at 1″ to about 1½″ more preferably 3″, giving this preferred embodiment a means of adjustability by aligning bored holes on 1-2 at a predetermined elevation and placing 5 through bored holes and locking 5 with clip 7 best shown in FIGS. 3 & 4 creating a telescopic member.

As shown in FIG. 13 a stabilizing bar 9 connects two workpiece holders as to allow a wide workpiece to be supported prior to being fastened to it's permanent location. The stabilizing bar is box tubing having one side with an outside measurement of the same or less, as the opposite box tubing inside measurement. Having bored holes through it's horizontal surface 10-11 from front to back, holes to be spaced 1″ or between 1½″ most preferably 3″.

To attach stabilizing bar 9-10-1 the upper members 2, a bored hole from front to back on 2 will be lined up with stabilizing bar holes and parts 5-7 will be means of securement to 2, as best seen in FIGS. 3-4-13. Both stabilizing bar tubes are locked by lining up holes on it's horizontal surfaces and placing 5 in bored holes and locking 5 with clip 7 forming a telescopic member, best shown in FIGS. 5-13. In FIG. 5 part 9 is a combination of parts 10-11, in this preferred embodiment.

The overall height of the present invention in this preferred embodiment in it's lowered state varies with the height of the workpiece to be installed and the height from the floor or a solid secured surface, as the invention could be modified to have a vertical height from as low as 10″ to a height of 12′ as there are no limitations relative to height of the invention.

In further accordance with the invention the complete workpiece holder system best seen in FIGS. 1-13, having 4 vertical members with means of adjustability. 4 workpiece holders at opposite ends of vertical members and a stabilizing bar with means of adjustability attached to workpiece holder horizontally as best seen in FIGS. 1-13.

The device of the present invention is used by placing the base member of two workpiece holders on a suitable solid secure surface and placing opposite ends 3 against a solid horizontal wall surface at desired elevations and width keeping plumb with base member of workpiece to be installed. Attach the stabilizing bar member to both devices with pin 5 and secure with clip 7. Place workpiece on workpiece holders 3 level and position. By striking bottom member toward wall with solid object this enables one to position and level workpiece. Then secure to wall or ceiling with appropriate fasteners and to adjoining workpieces if applicable.

Remove devices by striking bottom member outwards from the horizontal wall surface. Placing one hand on the bottom of uppers 3, relocating devices at the next location where a workpiece is to be installed if applicable. When having workpieces at different elevations adjust the devices by removing 7-5 on the vertical members and raising or lowering top 3 workpiece holder by placing your hand on the bottom side of 3 and aligning holes on members 1-2 at desired elevation. Reinstall 5-7. Repeat operation as stated above in the preferred embodiments if applicable.

Numerous variations will occur in the present invention without departing from the intended scope, for example the vertical members could be rectangular, square, round or other shapes. The top and bottom workpieces could be other than rectangular, such as circular, or triangular and any given length. The materials used could vary extensively as long as the materials used are structurally appropriate for the function they are to perform.

The invention is to be given it's fullest interpretation within the terms of the preferred embodiment and as defined by the appended claims.

What I claim as my invention is:

1. An adjustable positioning device, comprising:
a) of two longitudinal adjustable members having a workpiece holder end and an opposite end.
b) means of adjusting the length between said workpiece holder end and said opposite end of said longitudinal members.
c) means for securing the said longitudinal members to the predetermined length.
d) said securing means further comprising of two lower members having one end and an opposite end, said members further having upper members having one end and an opposite being of a lesser diameter adjacent to said ends.
e) said lower members having two holes at said opposite ends for means of said securing of members and work piece holder.
f) said upper members having various holes in members for means of securing said lower members to upper member bodies for means of securement.
g) said upper members having a hole at said opposite end of members as means of securing said work pieceholder.
e) a securing device member engaging in said holes of said upper members and said lower members to join said members and said workpiece holders.

2. An adjustable positioning device, comprising:
a) two longitudinal adjustable members having a workpiece holder end and opposite end.
b) means of securing the longitudinal members to a predetermined length.
c) means of adjusting the length of said longitudinal members between said work holding end and said opposite end.
d) means of adjusting said longitudinal members as to move said workpiece holder to said opposite end of longitudinal members; said adjusting means further comprising:
e) means of holding said workpiece and said members and said opposite end of predetermined position and said longitudinal members extend longitudinally and in other predetermined elevations said workpiece holder end of said longitudinal members move toward said opposite end.

3. An adjustable positioning device, comprising: as claimed in claims 1& 2 where-in said adjustable means further comprising:
a) holes in said upper and lower members securing device members engaging through said lower and upper members holes to form an adjustable member.

4. A work pieceholder as claimed in claim 1 and means of securing said holder further comprising:
a) two members having one end: and two holes on opposite sides and a workpiece holder having two ends and two sides, said work holder having holes at both ends and sides.
b) said sides and ends are joined together by aligning appropriate holes and inserting a securing device and retaining pin to lock said holder and said members, so as to create a pivoting point for said workpiece holder and piviotal movement.

5. An apparatus for stabilizing said members and work holders during attachment of the workpiece in a predetermined position said apparatus comprising of:
a) an adjustable member on a latitudinal plane to the work members that are used in a longitudinal plane.
b)adjustable members having an end and an opposite end.
c)said ends have holes on opposite sides to fasten to said work holder apparatus.
d)said adjustable members having said holes spaced appropriately to use said work holders at different latitudinal widths.
e) means of adjusting of said member having two members that slide in and over each member, having said holes for adjustability means.
f) means of joining members is a securing device with a locking pin.

6. A adjustable positioning device as claimed in claim 1 having a workpiece holder end further comprising of:
a) a flat surface member having an opposite end and two members both having opposite ends and one side of said members having one side of said member being of a longer surface, said flat member is attached to said members having a longer surface on one side; said workpiece holder is secured to said longitudinal adjustable members as said in claim 1.
b) said work holder is secured by means of securing device and locking pin.
c) as said workpiece holders are secured at both ends of adjustable members as said in claim 1, said workpiece holders are mirror image of each other therefore the adjustable positioning devices are universal and easy to use, lightweight and uncomplicated.
